(19) United States
(12) Patent Application Publication
(10) Pub. No.: US 2026/0088508 A1
(43) Pub. Date: Mar. 26, 2026

(54) ADAPTABLE LOW FREQUENCY RECEIVE ANTENNA AND METHOD

(71) Applicant: Rockwell Collins, Inc., Cedar Rapids, IA (US)

(72) Inventor: Jeffrey L. BOX, Farmersville, TX (US)

(73) Assignee: Rockwell Collins, Inc., Cedar Rapids, IA (US)

(21) Appl. No.: 18/894,433

(22) Filed: Sep. 24, 2024

(51) Int. Cl. H01Q 7/00; H04B 1/10; H04B 1/16

(52) U.S. Cl. CPC H01Q 7/00; H04B 1/1018; H04B 1/1036; H04B 1/1607

(57) ABSTRACT

An adaptable low frequency (LF) or very low frequency (VLF) receive antenna is configured to provide an amplified analog signal and/or a digital signal to a receiver. Such an adaptable LF/VLF receive antenna may be used with older generations of analog and digital receivers as well as newer generations of digital receivers that use a digital feed. Thus, an LF/VLF receive antenna in accordance with the present disclosure may be used to replace an existing antenna connected to an analog receiver and will continue to work when the analog receiver is upgraded in the future so as to ease the transition to newer digital receivers. In one or more embodiments, the digital signal may be further processed within the LF/VLF receive antenna so as to reduce its bandwidth and permit transmission of the processed digital signal over a data network.

### FIELD OF THE INVENTION

The subject matter disclosed herein relates to low frequency (LF) and very low frequency (VLF) receive antennas and, in particular, to an adaptable LF/VLF receive antenna for use with both analog and digital receivers.

### BACKGROUND OF THE INVENTION

With reference to FIG. 1, a traditional passive VLF antenna 10 is constructed with wire windings 12 wrapped around one or more ferrite cores 14, and other passive assemblies to convert a radio frequency (RF) signal in the air to a small electrical signal for further processing by a radio receiver. Such antennas include a shielded transmission line 16 between the antenna and the receiver. However, because of the weak nature of the received signals, the transmission line may pick up noise from other sources that serve to obscure the desired signal since the effectiveness of the shielding is limited.

With reference to FIG. 2, in order to improve the signal-to-noise ratio, a next step in the development of VLF antennas relates to an amplified VLF antenna 20, wherein an analog preamplifier 24 is provided within the antenna housing (e.g., electronics cavity) 22. The preamplifier 24 amplifies the received signals so as to overcome noise picked up in the transmission lines by outputting signals at higher amplitudes. In such an amplified VLF antenna 20, a power supply 26 provides power to the analog preamplifier 24 and line drivers 28 to provide a signal to a receiver. An example of such an antenna is disclosed in U.S. Pat. No. 3,495,264 to Spears.

VLF antennas 10 and 20 are generally configured to pass an analog signal to an analog receiver connection. For use with more recent digital receivers, many digital receivers may take the analog signal from the transmission line 16 and immediately digitize it. These receivers then employ a digital signal processing engine that performs the radio receiver functions in the digital domain. A significant challenge in their design is providing isolation to prevent electrical noise created by the signal processing hardware from contaminating the analog signal being fed into the digitizer. When this happens, the receiver capability is degraded by that noise contamination.

With reference to FIG. 3, one proposed solution to the digital noise produced by the digital signal processing engine is to migrate the digitizer 32 to the antenna 30 itself. The analog signal from the antenna 30 is then converted to digital samples and fed down the receive wiring connection 16. At that point, the antenna 30 transmits a digital stream to the receiver, which is now effectively a computer with no analog performance requirements. However, such an antenna 30 cannot be used with an analog or traditional digital receiver, and thus requires that both the antenna and receiver be upgraded at the same time. In many cases such as Department of Defense use, such LF/VLF antennas and/or receivers may cost many thousands of dollars, so the added expense is not trivial.

The above information disclosed in this Background section is only for understanding of the background of the inventive concepts and, therefore, it may contain information that does not constitute prior art.

### SUMMARY OF THE INVENTION

The present disclosure is directed, in a first aspect, to an adaptable low frequency (LF) or very low frequency (VLF) receive antenna. The LF/VLF antenna includes at least one ferrite core, a loop including a signal line having at least one set of signal windings wrapped around the at least one ferrite core, and an electronics cavity. The cavity houses an analog pre-amplifier having inputs connected to the loop, a digitizer connected to a first output of the analog pre-amplifier, and a mode switch connected to a second output of the analog pre-amplifier and an output of the digitizer. A power supply for the electronics may be disposed within the cavity or external thereto. The mode switch is configured to output either an analog signal of the second output of the analog pre-amplifier or a digital signal from the output of the digitizer based upon a position of the mode switch.

In one or more embodiments, the signal windings of the adaptable LF/VLF receive antenna may be adapted for operation in a range of 3-300 kHz or subset thereof.

In other embodiments, the mode switch may further include drivers for the analog signal or the digital signal.

In an embodiment, the power supply, analog pre-amplifier, digitizer, and mode switch may be disposed in the electronics cavity and the analog pre-amplifier, digitizer, and mode switch may be connected to the power supply.

In another embodiment, the mode switch may include a manual actuator.

In a further embodiment, the mode switch may include a controller adapted to detect a receiver connection type and actuate the mode switch.

In yet another embodiment, the controller may detect the receiver connection type based upon test signals received from the receiver.

In an embodiment, the adaptable LF/VLF receive antenna may further include an auxiliary processor, wherein the output of the digitizer may be connected to an input of the auxiliary processor and an output of the auxiliary processor may be connected mode switch to provide a processed digital output as the output of the digitizer.

In another embodiment, the auxiliary processor may provide at least one of channel tuning, down conversion, noise suppression, signal filtering, and demodulation.

In a further embodiment, the auxiliary processor may include a field-programmable gate array (FPGA).

In yet another embodiment, the processed digital output may reduce a bandwidth of the digital signal for transmission over a data network.

In another embodiment, the present disclosure is directed to a low frequency (LF) or very low frequency (VLF) receive antenna that includes at least one ferrite core, a loop including a signal line having at least one set of signal windings wrapped around the at least one ferrite core, an electronics cavity, and a power supply. The LF/VLF antenna in this embodiment also includes an analog pre-amplifier disposed in the electronics cavity and having inputs connected to the loop, a digitizer disposed in the electronics cavity and connected to a first output of the analog pre-amplifier, a signal driver disposed in the electronics cavity and connected to a second output of the analog pre-amplifier, and an auxiliary processor disposed in the electronics cavity. The output of the digitizer is connected to an input of the auxiliary processor and an output of the auxiliary processor is connected to the signal driver to provide a processed digital output as the output of the digitizer. The signal driver is configured to provide a substantially simultaneous output of an analog signal of the second output of the analog pre-amplifier and a digital signal of the processed digital output, and the analog pre-amplifier, digitizer, and mode switch are connected to the power supply.

In another embodiment, the auxiliary processor may provide at least one of channel tuning, down conversion, noise suppression, signal filtering, and demodulation.

In a further embodiment, the auxiliary processor may include a field-programmable gate array (FPGA).

In yet another embodiment, the processed digital output may reduce a bandwidth of the digital signal for transmission over a data network.

In yet another embodiment, the present disclosure is directed to a method of operating a low frequency (LF) or very low frequency (VLF) receive antenna. The method includes receiving an analog signal on the LF/VLF receive antenna having at least one ferrite core and a plurality of signal windings wrapped around the at least one ferrite core, amplifying the analog signal in a pre-amplifier disposed in an electronics cavity of the LV/VLF receive antenna, digitizing the amplified analog signal with a digitizer disposed in the electronics cavity of the LV/VLF receive antenna to produce a digital signal, processing the digital signal with an auxiliary processor disposed in the electronics cavity of the LV/VLF receive antenna to produce a processed digital output having a reduced bandwidth, and driving an output of the amplified analog signal and/or the processed digital output with drivers disposed in the electronics cavity of the LV/VLF receive antenna.

In an embodiment of the method, the drivers may output both the amplified analog signal and the processed digital output.

In another embodiment of the method, the drivers may output the amplified analog signal and the processed digital output substantially simultaneously.

In a further embodiment of the method, the processed digital output may be transmitted over a data network.

In yet another embodiment of the method, the processed digital output may be received at a digital receiver computer connected to the data network.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a schematic diagram of a prior art analog VLF loop antenna;

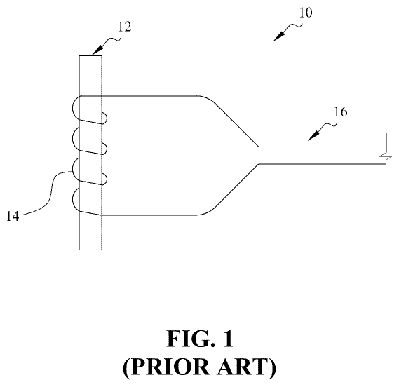

FIG. 2 is a schematic diagram of a prior art amplified analog VLF loop antenna;

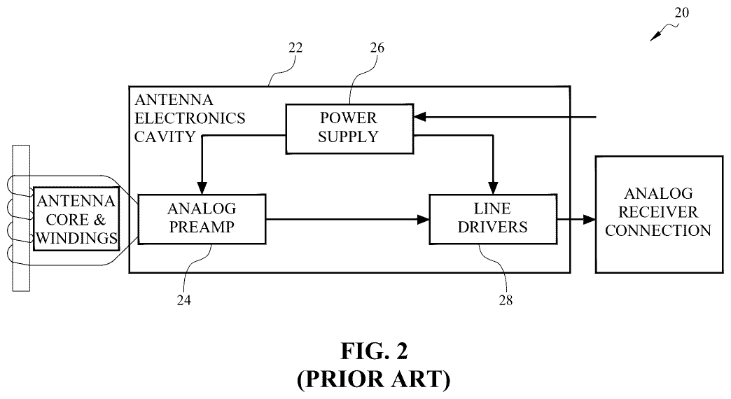

FIG. 3 is a schematic diagram of a prior art amplified digital VLF loop antenna;

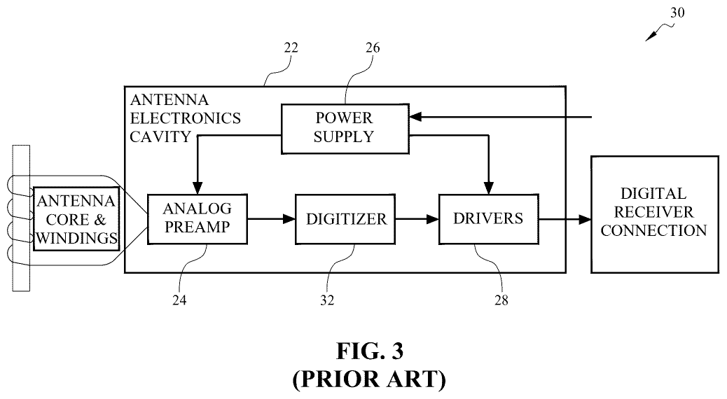

FIG. 4 is a schematic diagram of an amplified hybrid analog/digital VLF loop antenna in accordance with the present disclosure;

FIG. 5 is a schematic diagram of another amplified hybrid analog/digital VLF loop antenna having auxiliary functions in accordance with the present disclosure;

FIG. 6 is a schematic diagram of network connected antennas enabled by amplified hybrid analog/digital VLF loop antennas in accordance with the present disclosure;

FIG. 7 is a schematic diagram of an amplified hybrid analog/digital VLF loop antenna with simultaneous analog and digital output signals in accordance with the present disclosure; and

FIG. 8 is a flow diagram of a method of using an amplified hybrid analog/digital VLF loop antenna in accordance with the present disclosure.

### DETAILED DESCRIPTION OF THE INVENTION

The embodiments of the present disclosure can comprise, consist of, and consist essentially of the features and/or steps described herein, as well as any of the additional or optional elements, components, steps, or limitations described herein or would otherwise be appreciated by one of skill in the art.

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting.

The present disclosure is directed to an adaptable low frequency (LF) or very low frequency (VLF) receive antenna that can provide an amplified analog signal and/or a digital signal to a receiver or other device. Such an adaptable LF/VLF receive antenna may be used with older generations of analog and digital receivers as well as newer generations of digital receivers that use a digital feed. Thus, an LF/VLF receive antenna in accordance with the present disclosure may be used to replace an existing antenna connected to an analog receiver and will continue to work when the analog receiver is upgraded in the future so as to ease the transition to newer digital receivers. In one or more embodiments, the digital signal may be further processed within the LF/VLF receive antenna so as to reduce its bandwidth and permit transmission of the processed digital signal over a data network.

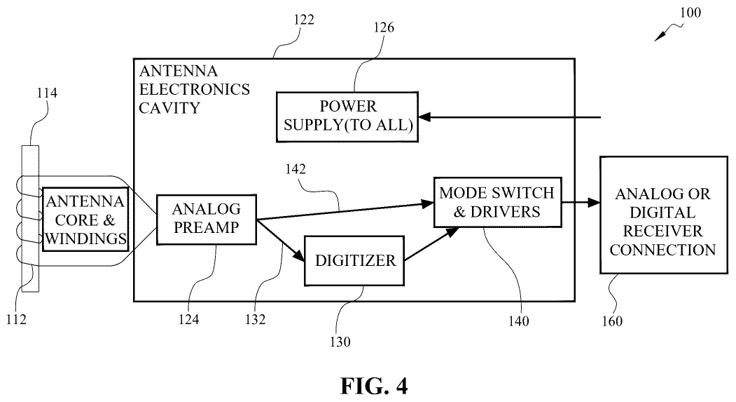

Referring to FIG. 4, in one or more embodiments, an adaptable LF/VLF receive antenna 100 includes at least one ferrite core 114 and a loop including a signal line having at least one set of signal windings 112 wrapped around the at least one ferrite core 114. For example, a plurality of ferrite cores 114 and signal windings 114 as disclosed in U.S. Pat. No. 3,495,264 to Spears may be used. In an embodiment, the signal windings 112 and ferrite core(s) 114 may be adapted for acquiring signals in an operation range between 3 kHz and 300 kHz or any subset thereof (with, e.g., 3-30 kHz being considered VLF and 30-300 kHz being considered LF). In another embodiment, the signal windings 112 and ferrite core(s) 114 may be adapted for acquiring signals in an operation range between 14 kHz and 60 kHz.

LF/VLF receive antenna 100 further includes an electronics cavity 122 for housing a variety of electronics associated with the LF/VLF receive antenna 100. The electronics cavity 122 may include shielding to prevent or reduce external electronic noise as well as noise between the internal electronics. LF/VLF receive antenna 100 may further include a power supply 126, an analog pre-amplifier 124 having inputs connected to the loop, a digitizer 130 connected to a first output 132 of the analog pre-amplifier 124, and a mode switch 140 connected to a second output 142 of the analog pre-amplifier 124. The mode switch 140 is further connected to an output of the digitizer 130.

In an embodiment, the analog pre-amplifier 124 may be, for example, a circuit based upon a modern low-noise operational amplifier such as the Analog Devices AD797, the digitizer 130 may be, for example, a 24-bit analog-to-digital converter such as the Texas Instruments ADS1675, and the power supply 126 may be a small high-frequency switching power supply operating at a frequency above the receive frequency band.

In an embodiment, the mode switch 140 is configured to output either an analog signal of the second output of the analog pre-amplifier 124 or a digital signal from the output of the digitizer 130 based upon a position of the mode switch 140. Thus, when connected to an analog receiver connection 160, the mode switch 140 can be configured use drivers to send the analog signal out via transmission line to the analog receiver. Similarly, when connected to a digital receiver connection 160, the mode switch 140 can be configured use drivers to send the digital signal out via transmission line to the digital receiver. In an embodiment, the drivers may include twisted pair Ethernet drivers.

In one embodiment, the switching element of the mode switch 140 may be a manual switch of any suitable design with manually-actuated positions for analog output and digital output. However, in many cases the LF/VLF receive antenna 100 may not be readily accessible, such that automatic or remote operation may be desirable. In one or more embodiments, the mode switch 140 may include a controller that may be remotely operated (wired or wirelessly) to switch between positions for analog output and digital output. In other embodiments, the controller may detect the receiver connection type based upon test signals received from the connected receiver and then automatically switch between positions for analog output and digital output based upon the detected connection type. For example, a controller for mode switch 140 may include a small system-on-a-chip processor such as the Microchip SAM V70. The mode switch 140 in one or more embodiments may further include drivers for outputting the analog signal and/or digital signal.

In one or more embodiments, the power supply 126, analog pre-amplifier 124, digitizer 130, and mode switch 140 may be disposed within the electronics cavity 122, with each of the analog pre-amplifier 124, digitizer 130, and mode switch 140 being connected to the power supply 126. However, embodiments of the present disclosure are not limited thereto, and in other embodiments, for example, the power supply 126 may be separately disposed, shielded, and positioned exterior to the electronics cavity 122 of the LF/VLF receive antenna 100. The electronics cavity 122 may be disposed in any suitable position/location adjacent the loop portion of the receive antenna 100 and include shielding from exterior sources of electronic noise as is known in the art.

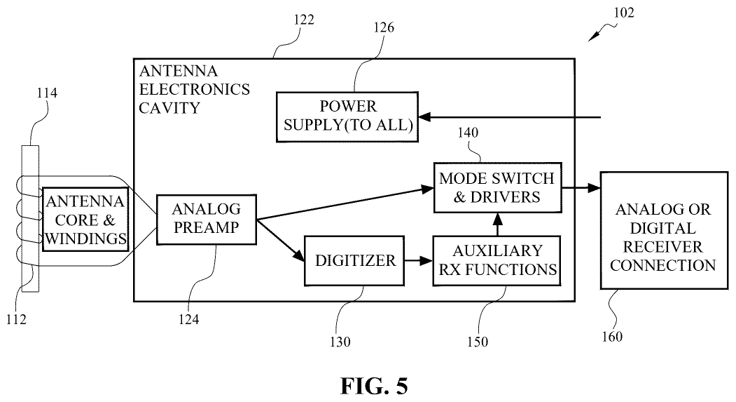

Referring to FIG. 5, in one or more embodiments, the LF/VLF receive antenna 102 in accordance with the present disclosure may further include an auxiliary processor 150 to provide auxiliary functions to the LF/VLF receive antenna 102, such as digital receiver functions. For example, in various embodiments, the auxiliary processor 150 may provide at least one digital receiver function selected from channel tuning, down conversion, noise suppression, signal filtering, and demodulation. In an embodiment, the auxiliary processor 150 may be a field-programmable gate array (FPGA) such as the Altera 5CEFA9F2317N.

As illustrated in FIG. 5, the output of the digitizer 130 in this embodiment is connected to an input of the auxiliary processor 150, and an output of the auxiliary processor 150 is connected mode switch 140 to provide a processed digital output as the output of the digitizer to the mode switch 140. Dependent upon the position of mode switch 140, drivers in mode switch 140 may output an amplified analog signal or a processed digital signal to an analog receiver connection 160 or digital receiver connection 160, respectively. In one or more embodiments, the processed digital output from auxiliary processor 150 may have a reduced bandwidth so that instead of outputting the entire spectrum of the received signal, the LF/VLF receive antenna 102 may output a selected portion of information that is of interest to the receiver. Such a digital signal with a reduced bandwidth uses fewer resources to transmit over a data network, such as a packet-switched Internet Protocol (IP) network. The transmission of the digital signal over a data network permits expanded utility and applications for the LF/VLF receive antenna 102.

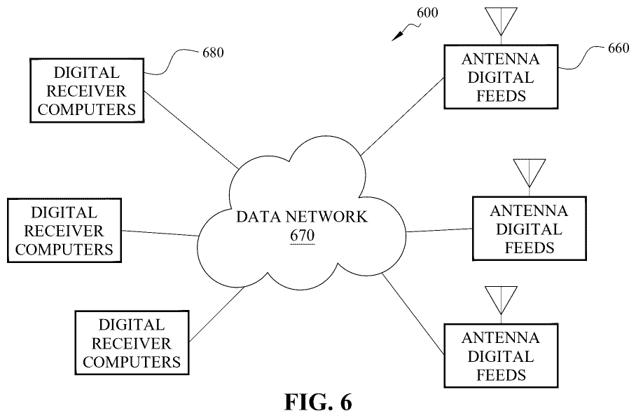

For example, referring to FIG. 6, in a networked antenna system 600, one or more LF/VLF receive antennas 102 may produce reduced bandwidth digital feeds 660. The digital feeds 660 may be transmitted over a data network 670 to one or more digital receiver computers 680 that are connected to the data network 670.

In one application of networked antenna system 600, the antennas providing digital feeds 660 and receivers of the digital receiver computers 680 may be geographically dispersed and connected by data network 670 to facilitate spectrum monitoring, direction finding, and intelligence collection. In another application, networked antenna system 600 may be used to facilitate ground monitoring of LF/VLF transmitters (such as those used by the U.S. Department of Defense for text transmission or the WWVH 60 kHz broadcast from the National Institute of Science and Technology (NIST) for time signals) to validate signal coverage models.

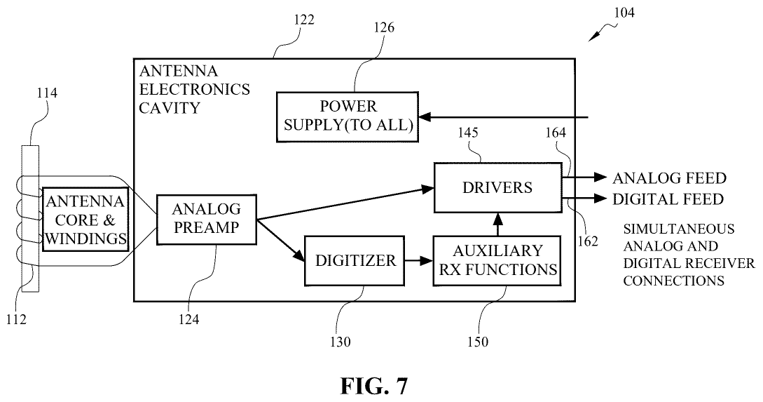

Referring to FIG. 7, in one or more further embodiments, the LF/VLF receive antenna 104 may omit or otherwise bypass use of the mode switch 140 and instead provide both a digital feed 162 and an analog feed 164 to the analog and digital receiver connections 160. In an embodiment, the digital feed 162 and the analog feed 164 may be provided to the analog and digital receiver connections 160 substantially simultaneously.

As with the earlier embodiments of the adaptable LF/VLF receive antennas 100 and 102, the adaptable LF/VLF receive antenna 104 includes at least one ferrite core 114 and a loop including a signal line having at least one set of signal windings 112 wrapped around the at least one ferrite core 114. In an embodiment, the signal windings 112 and ferrite core(s) 114 may be adapted for acquiring signals in an operation range between 3 kHz and 300 kHz or any subset thereof (with, e.g., 3-30 kHz being considered VLF and 30-300 kHz being considered LF) or an operation range between 14 kHz and 60 kHz.

LF/VLF receive antenna 104 further includes an electronics cavity 122 for housing the electronics associated with the LF/VLF receive antenna 104. LF/VLF receive antenna 104 includes a power supply 126, an analog pre-amplifier 124 having inputs connected to the loop, a digitizer 130 connected to a first output 132 of the analog pre-amplifier 124. LF/VLF receive antenna 104 differs from LF/VLF receive antennas 100 and 102 in that the mode switch 140 is replaced by drivers 145 having inputs to receive a second output 142 of the analog pre-amplifier 124 and an output of the digitizer 130 after being processed by auxiliary processor 150.

In one or more embodiments, the power supply 126, analog pre-amplifier 124, digitizer 130, auxiliary processor 150, and drivers 145 may be disposed in the electronics cavity 122, with each of the analog pre-amplifier 124, digitizer 130, auxiliary processor 150, and drivers 145 being connected to the power supply 126. However, embodiments of the present disclosure are not limited thereto, and in other embodiments, for example, the power supply 126 may be separately disposed and positioned exterior to the electronics cavity 122 of the LF/VLF receive antenna 104. The electronics cavity 122 may be disposed in any suitable position/location adjacent the loop portion of the receive antenna 104 and should be shielded from exterior sources of noise.

As with the LF/VLF receive antenna 102, the auxiliary processor 150 in LF/VLF receive antenna 104 may provide auxiliary functions, such as digital receiver functions. For example, in various embodiments, the auxiliary processor 150 may provide at least one digital receiver function selected from channel tuning, down conversion, noise suppression, signal filtering, and demodulation. In an embodiment, the auxiliary processor 150 may be a field-programmable gate array (FPGA).

As illustrated in FIG. 7, the output of the digitizer 130 in this embodiment is connected to an input of the auxiliary processor 150, and an output of the auxiliary processor 150 is connected drivers 145 to provide a processed digital output as the output of the digitizer to the drivers 145. Drivers 145 output an amplified analog signal and a processed digital signal to an analog receiver connection 160 and a digital receiver connection 160 substantially simultaneously. In one or more embodiments, the processed digital output from auxiliary processor 150 may have a reduced bandwidth so that instead of outputting the entire spectrum of the received signal, the LF/VLF receive antenna 104 may output a selected portion of information that is of interest to the receiver having the receiver connection 160.

In one or more embodiment, the drivers 145 include at least one signal driver configured to provide a substantially simultaneous output of an analog signal of the second output of the analog pre-amplifier 124 and a digital signal of the processed digital output of auxiliary processor 150. In various embodiments, the processed digital output from the auxiliary processor 150 has a reduced bandwidth for transmission over a network, such as data network 670.

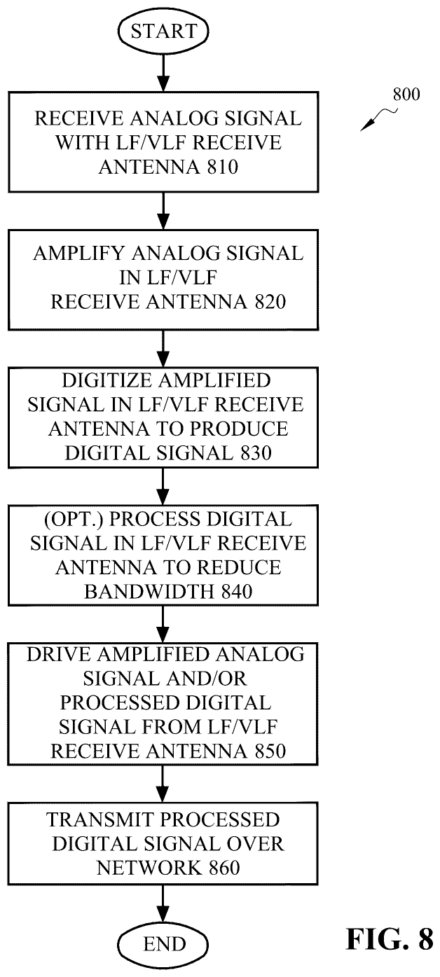

Referring to FIG. 8, in one or more embodiments, the present disclosure is drawn to a method 800 of operating a LF/VLF receive antenna such as LF/VLF receive antenna 102 or 104. The method 800 starts and in a first step 810, the LF/VLF receive antenna 102 or 104 receives an analog signal on the LF/VLF receive antenna 102 or 104, which has at least one ferrite core 114 and a plurality of signal windings 112 wrapped around the at least one ferrite core 114.

In a next step 820, the LF/VLF receive antenna 102 or 104 amplifies the analog signal in a pre-amplifier 124 disposed in an electronics cavity 122 of the LV/VLF receive antenna 102 or 104. The LF/VLF receive antenna 102 or 104 then digitizes the amplified analog signal with a digitizer 130 disposed in the electronics cavity 122 of the LV/VLF receive antenna 102 or 104 to produce a digital signal at step 830.

In a next step 840, an auxiliary processor 150 disposed in an electronics cavity 122 of the LV/VLF receive antenna 102 or 104 processes the digital signal to produce a processed digital output having a reduced bandwidth. Drivers 145 disposed in the electronics cavity of the LV/VLF receive antenna 102 or 104 then drive an output of the amplified analog signal and/or the processed digital output at step 850. In an embodiment, the drivers 145 output both the amplified analog signal and the processed digital output, and may do so substantially simultaneously to respective analog and digital receiver connections 160, such as via the analog feed 164 and digital feed 162 of FIG. 7.

In one or more embodiment, the method 800 may further include transmitting, at step 860, the processed digital output over a data network 670. The transmission may be made directly from digital feed 162 of LF/VLF receive antenna 104, or may be performed by a connected digital receiver which relays the digital feed 660.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. An adaptable low frequency (LF) or very low frequency (VLF) receive antenna, comprising:
at least one ferrite core;
a loop including a signal line having at least one set of signal windings wrapped around the at least one ferrite core;
an electronics cavity;
a power supply;
an analog pre-amplifier having inputs connected to the loop;
a digitizer connected to a first output of the analog pre-amplifier;
a mode switch connected to a second output of the analog pre-amplifier and an output of the digitizer, wherein the mode switch is configured to output either an analog signal of the second output of the analog pre-amplifier or a digital signal from the output of the digitizer based upon a position of the mode switch.

2. The adaptable LF/VLF receive antenna of claim 1, wherein the signal windings are adapted for operation in a range of 3-300 kHz or subset thereof.

3. The adaptable LF/VLF receive antenna of claim 1, wherein the mode switch further comprises drivers for the analog signal or the digital signal.

4. The adaptable LF/VLF receive antenna of claim 1, wherein the power supply, analog pre-amplifier, digitizer, and mode switch are disposed in the electronics cavity and the analog pre-amplifier, digitizer, and mode switch are connected to the power supply.

5. The adaptable LF/VLF receive antenna of claim 1, wherein the mode switch comprises a manual actuator.

6. The adaptable LF/VLF receive antenna of claim 1, wherein the mode switch comprises a controller adapted to detect a receiver connection type and actuate the mode switch in response to the detected receiver connection type.

7. The adaptable LF/VLF receive antenna of claim 6, wherein the controller detects the receiver connection type based upon test signals received from the receiver.

8. The adaptable LF/VLF receive antenna of claim 1, further comprising an auxiliary processor, wherein the output of the digitizer is connected to an input of the auxiliary processor and an output of the auxiliary processor is connected mode switch to provide a processed digital output as the output of the digitizer.

9. The adaptable LF/VLF receive antenna of claim 8, wherein the auxiliary processor provides at least one of channel tuning, down conversion, noise suppression, signal filtering, and demodulation.

10. The adaptable LF/VLF receive antenna of claim 9, wherein the auxiliary processor comprises a field-programmable gate array (FPGA).

11. The adaptable LF/VLF receive antenna of claim 9, wherein the processed digital output reduces a bandwidth of the digital signal for transmission over a data network.

12. A low frequency (LF) or very low frequency (VLF) receive antenna, comprising:
at least one ferrite core;
a loop including a signal line having at least one set of signal windings wrapped around the at least one ferrite core;
an electronics cavity;
a power supply;
an analog pre-amplifier disposed in the electronics cavity and having inputs connected to the loop;
a digitizer disposed in the electronics cavity and connected to a first output of the analog pre-amplifier;
a signal driver disposed in the electronics cavity and connected to a second output of the analog pre-amplifier; and
an auxiliary processor disposed in the electronics cavity, wherein the output of the digitizer is connected to an input of the auxiliary processor and an output of the auxiliary processor is connected to the signal driver to provide a processed digital output as the output of the digitizer,
wherein the signal driver is configured to provide a substantially simultaneous output of an analog signal of the second output of the analog pre-amplifier and a digital signal of the processed digital output, and
wherein the analog pre-amplifier, digitizer, and mode switch are connected to the power supply.

13. The adaptable LF/VLF receive antenna of claim 12, wherein the auxiliary processor provides at least one of channel tuning, down conversion, noise suppression, signal filtering, and demodulation.

14. The adaptable LF/VLF receive antenna of claim 13, wherein the auxiliary processor comprises a field-programmable gate array (FPGA).

15. The adaptable LF/VLF receive antenna of claim 12, wherein the processed digital output reduces a bandwidth of the digital signal for transmission over a data network.

16. A method of operating a low frequency (LF) or very low frequency (VLF) receive antenna, comprising:
receiving an analog signal on the LF/VLF receive antenna having at least one ferrite core and a plurality of signal windings wrapped around the at least one ferrite core;
amplifying the analog signal in a pre-amplifier disposed in an electronics cavity of the LV/VLF receive antenna;
digitizing the amplified analog signal with a digitizer disposed in the electronics cavity of the LV/VLF receive antenna to produce a digital signal;
processing the digital signal with an auxiliary processor disposed in the electronics cavity of the LV/VLF receive antenna to produce a processed digital output having a reduced bandwidth; and
driving an output of the amplified analog signal and/or the processed digital output with drivers disposed in the electronics cavity of the LV/VLF receive antenna.

17. The method of claim 16, wherein the drivers output both the amplified analog signal and the processed digital output.

18. The method of claim 17, wherein the drivers output the amplified analog signal and the processed digital output substantially simultaneously.

19. The method of claim 16, wherein the processed digital output is transmitted over a data network.

20. The method of claim 19, wherein the processed digital output is received at a digital receiver computer connected to the data network.
